(19) United States
(12) Patent Application Publication
(10) Pub. No.: US 2024/0300462 A1
(43) Pub. Date: Sep. 12, 2024

(54) VEHICLE BRAKE APPARATUS

(71) Applicants: HONDA MOTOR CO., LTD., Tokyo (JP); Hitachi Astemo Ueda, Ltd., Nagano (JP)

(72) Inventors: Ryo Ueki, Tokyo (JP); Motomasa Suzuki, Tokyo (JP); Akihisa Hirata, Tokyo (JP); Tadashi Yamashita, Nagano (JP); Yuki Katagiri, Nagano (JP); Susumu Kobayashi, Nagano (JP)

(21) Appl. No.: 18/592,993

(22) Filed: Mar. 1, 2024

(30) Foreign Application Priority Data
Mar. 7, 2023 (JP) 2023-034232

(51) Int. Cl. B60T 11/22; F15B 1/26

(52) U.S. Cl. CPC B60T 11/22; F15B 1/26; B60T 11/26

(57) ABSTRACT

A reservoir tank has an overhanging portion hanging over a master cylinder toward a front side of a vehicle. The guide member has a fixed portion to be fixed to the master cylinder, and an extending portion extending toward the front side of the vehicle from the fixed portion and overlapping the overhanging portion in a vehicle up-down direction. Moreover, the overhanging portion has a rib portion protruding toward a lower side of the vehicle, and at least part of this rib portion overlaps the extending portion in a vehicle front-rear direction.

### CROSS-REFERENCE TO RELATED APPLICATION

This application is based upon and claims priority from the Japanese Patent Application No. 2023-034232, filed on Mar. 7, 2023, the entire contents of which are incorporated herein by reference.

### BACKGROUND OF THE INVENTION

### 1. Field of the Invention

The present invention relates to a vehicle brake apparatus including a master cylinder and a reservoir tank mounted to a portion of the master cylinder on the upper side of the vehicle.

### 2. Description of the Related Art

JP3386765B, for example, discloses a technology in which an end region of a master cylinder on the front side of a vehicle and a guide member provided to its engine (mechanical forced guidance means) cause the master cylinder to tilt clockwise in the event of a vehicle collision.

Incidentally, conventional master cylinders have become smaller in the dimension in the vehicle front-rear direction. This leads to a possibility that the reservoir tank mounted to such a master cylinder hangs over the end of the master cylinder on the front side of the vehicle (hereinafter “vehicle front end”) toward the front side of the vehicle.

Also, when the reservoir tank is de-aired, a jig is mounted on the reservoir tank's cap and vacuuming is performed. At this time, the jig applies a load toward the lower side of the vehicle. Thus, in the case where the dimension of the master cylinder in the vehicle front-rear direction is so short that the reservoir tank hangs over the vehicle front end of the master cylinder, it is difficult to support the reservoir tank against the load toward the lower side of the vehicle.

The present invention has been made in view of the above circumstance, and an object thereof is to provide a vehicle brake apparatus capable of supporting its reservoir tank even in the case where the dimension of its master cylinder in the vehicle front-rear direction is so short that the reservoir tank hangs over the vehicle front end of the master cylinder.

### SUMMARY OF THE INVENTION

In order to achieve the above object, the present invention includes: a master cylinder mounted to a dash panel of a vehicle; a reservoir tank mounted to a portion of the master cylinder on an upper side of the vehicle; and a guide member provided at an end portion of the master cylinder on a front side of the master cylinder, wherein the reservoir tank having an overhanging portion hanging over the master cylinder toward a front side of the vehicle. The guide member has a fixed portion to be fixed to the master cylinder, and an extending portion extending toward the front side of the vehicle from the fixed portion and overlapping the overhanging portion in a vehicle up-down direction. The overhanging portion has a rib portion protruding toward a lower side of the vehicle. At least part of the rib portion overlaps the extending portion in a vehicle front-rear direction.

In accordance with the present invention, it is possible to obtain a vehicle brake apparatus capable of supporting its reservoir tank even in the case where the dimension of its master cylinder in the vehicle front-rear direction is so short that the reservoir tank hangs over the vehicle front end of the master cylinder.

### BRIEF DESCRIPTION OF THE DRAWINGS

FIG. 1 is a perspective view showing a structure of a vehicle brake apparatus according to an embodiment of the present invention.

FIG. 2 is a partial enlarged perspective view of the vehicle brake apparatus shown in FIG. 1 as seen from the front side of the vehicle.

FIG. 3 is an arrow view as seen from the direction of the arrow A in FIG. 2.

FIG. 4 is a perspective view of the vehicle brake apparatus shown in FIG. 1 as seen obliquely from the front side of the vehicle.

FIG. 5 is an enlarged perspective view showing a fixed portion and an extending portion.

FIG. 6 is an enlarged perspective view of a guide member.

FIG. 7 is a side view of a rib portion provided on the bottom surface of a reservoir tank.

FIG. 8 is a bottom view corresponding to FIG. 3 and showing a downwardly protruding portion provided on the bottom surface of the reservoir tank.

### DETAILED DESCRIPTION OF THE EMBODIMENTS

Next, an embodiment of the present invention will be described in detail with reference to drawings as appropriate. In the drawings, “front-rear” represents a vehicle front-rear direction, “left-right” represents a vehicle width direction (left-right direction), and “up-down” represents a vehicle up-down direction (vertically up-down direction).

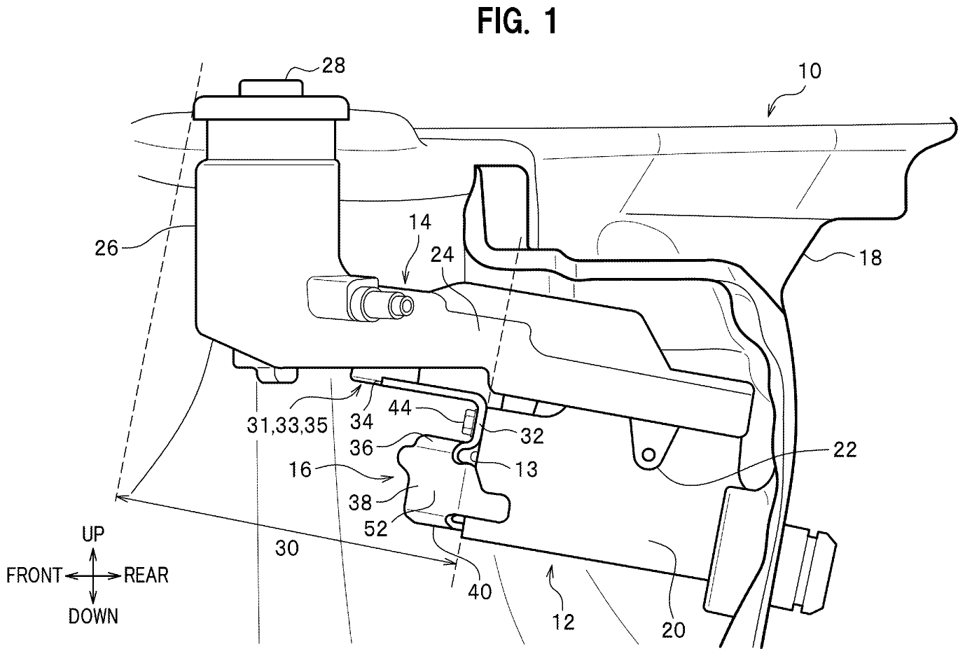

As shown in FIG. 1, a vehicle brake apparatus 10 according to an embodiment of the present invention includes a master cylinder 12, a reservoir tank 14, and a guide member 16.

This master cylinder 12 includes a cylinder body 20, a piston not shown, and a piston rod not shown. An end portion of the master cylinder 12 on the rear side of the vehicle (hereinafter “vehicle rear end portion”) is mounted to a lower dash panel 18. The cylinder body 20 assumes a tubular shape with both axial ends closed. The piston is set inside the cylinder body 20 and reciprocally moves along the axial direction of the cylinder body 20. The piston rod is coupled to the piston and reciprocally moves together with the piston.

As shown in FIG. 1, the lower dash panel 18 separates the power plant room in which power units such as an engine and a motor (not shown) are disposed, and the cabin. A brake pedal (not shown) is coupled to the vehicle rear end portion of the master cylinder 12 via a push rod (not shown).

The reservoir tank 14 is mounted to a portion of the master cylinder 12 on the upper side of the vehicle via a mount piece 22. This reservoir tank 14 includes a tank body 24, a tubular protruding portion 26, and a cap 28. The tank body 24 is made of a resin, for example, and stores a brake fluid inside. The tubular protruding portion 26 is provided at the vehicle front end of the tank body 24 so as to protrude toward the upper side of the vehicle. The cap 28 is provided so as to detachably open and close an opening portion (not shown) provided in the upper end of the tubular protruding portion 26.

The reservoir tank 14 also has an overhanging portion 30 hanging over an end surface 13 of the master cylinder 12 on the front side of the vehicle (hereinafter “vehicle front end surface”) toward the front side of the vehicle. This overhanging portion 30 includes part of the tank body 24 hanging over the vehicle front end surface 13 of the master cylinder 12 toward the front side of the vehicle, and the tubular protruding portion 26 continuous with this part of the tank body 24.

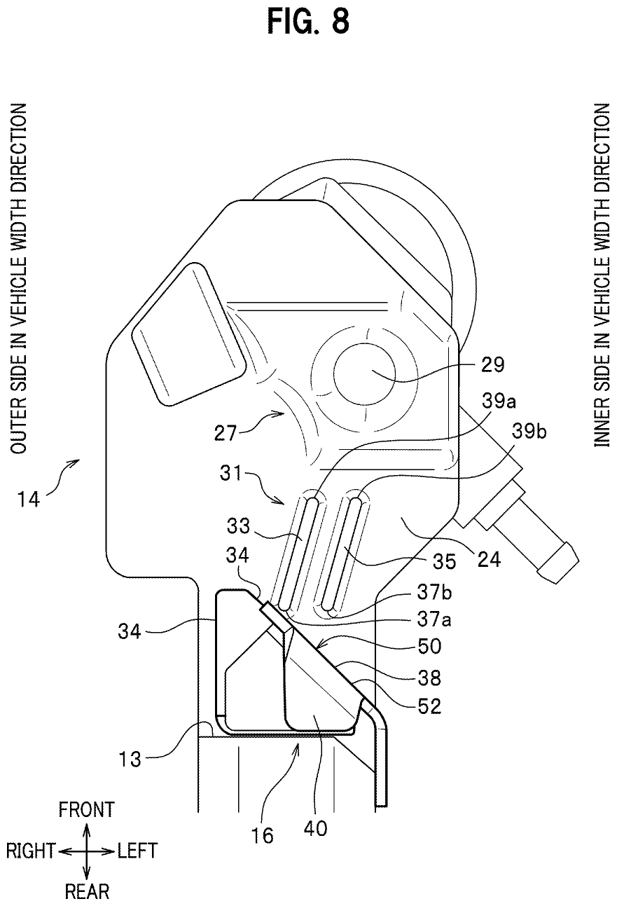

The overhanging portion 30 of the reservoir tank 14 also has a downwardly protruding portion 27 located on the lower side of the tubular protruding portion 26 and protruding downward from the bottom surface of the tank body 24 (see FIG. 8). This downwardly protruding portion 27 assumes a substantially trapezoidal shape in a bottom view, and a single circular convex portion 29 is provided on its center (see FIG. 8).

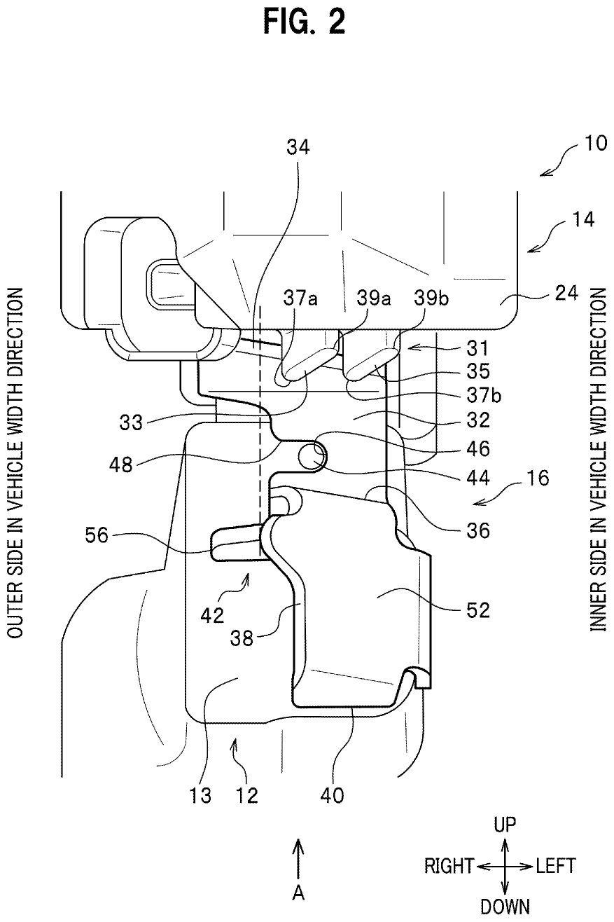

The overhanging portion 30 of the reservoir tank 14 further has a rib portion 31 protruding toward the lower side of the vehicle (see FIG. 1). At least part of this rib portion 31 is provided so as to overlap a later-described extending portion 34 of the guide member 16 in the vehicle front-rear direction (see FIG. 1). Moreover, the rib portion 31 is disposed outward of at least part of a later-described abutment surface 52 of the guide member 16 in the vehicle width direction as viewed from the side where the vehicle front end surface 13 of the master cylinder 12 is (see FIG. 2). Furthermore, the rib portion 31 is disposed between the downwardly protruding portion 27 of the reservoir tank 14 and the extending portion 34 of the guide member 16 in the vehicle front-rear direction (see FIG. 8).

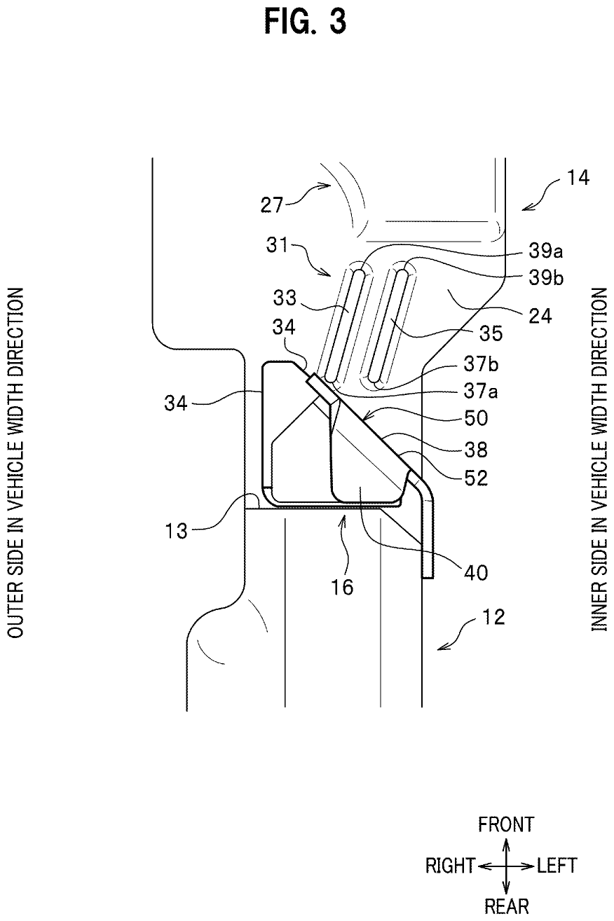

As shown in FIG. 3, the rib portion 31 is disposed to be tilted along the vehicle front-rear direction. Also, the rib portion 31 includes a first rib 33 and a second rib 35 extending parallel or substantially parallel to each other substantially in the vehicle front-rear direction. The first rib 33 is disposed outward of the second rib 35 in the vehicle width direction. The second rib 35 is disposed inward of the first rib 33 in the vehicle width direction.

In the present embodiment, the first and second ribs 33 and 35 are disposed parallel or substantially parallel to each other but are not limited to this arrangement. For example, the first and second ribs 33 and 35 may be disposed such that an extension of the former and an extension of the latter crosses each other. Also, in the present embodiment, the rib portion 31 includes multiple ribs (the first and second ribs 33 and 35) but may only include a single rib.

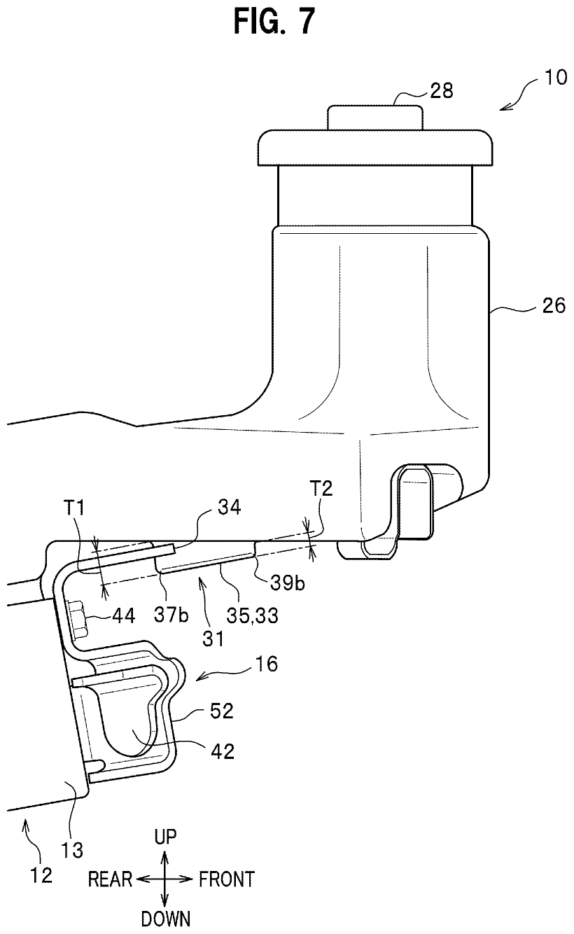

Vehicle rear end portions 37a and 37b of the first and second ribs 33 and 35 are each disposed inward of a later-described tapered portion 50 of the guide member 16 in the vehicle width direction (see FIG. 3). Moreover, the vehicle rear end portions 37a and 37b of the first and second ribs 33 and 35 are disposed so as to overlap the later-described tapered portion 50 of the guide member 16 (an edge portion of the extending portion 34 on the inner side in the vehicle width direction) in the vehicle width direction. Furthermore, at least part of the later-described extending portion 34 of the guide member 16 is disposed to be higher than the lower ends of the vehicle rear end portions 37a and 37b of the rib portion 31 (see FIG. 7).

The vehicle rear end portions 37a and 37b of the rib portion 31 are disposed outward of end portions 39a and 39b of the rib portion 31 on the front side of the vehicle (hereinafter “vehicle front end portions”) in the vehicle width direction, respectively (see FIG. 3). In other words, the vehicle front end portions 39a and 39b of the first and second ribs 33 and 35 are disposed inward of the vehicle rear end portions 37a and 37b of the first and second ribs 33 and 35 in the vehicle width direction, respectively.

As shown in FIG. 7, a thickness T1 of the vehicle rear end portions 37a and 37b of the first and second ribs 33 and 35 toward the lower side (protruding height) is larger than a thickness T2 of the vehicle front end portions 39a and 39b of the first and second ribs 33 and 35 toward the lower side (protruding height) (T1>T2). In this way, when a screw member 44 for a fixed portion 32 is fastened or removed, it is possible to avoid interference with a tool (not shown) in a preferable manner.

The vehicle rear end portion 37a of the first rib 33 is disposed closer to the tapered portion 50 of the guide member 16 (the edge portion of the extending portion 34 on the inner side in the vehicle width direction) than the vehicle rear end portion 37b of the second rib 35 is (see FIG. 3).

Moreover, the vehicle rear end portions 37a and 37b of the rib portion 31 are disposed closer to the tapered portion 50 of the guide member 16 (the edge portion of the extending portion 34 on the inner side in the vehicle width direction) than the vehicle front end portions 39a and 39b of the rib portion 31 are (see FIG. 3).

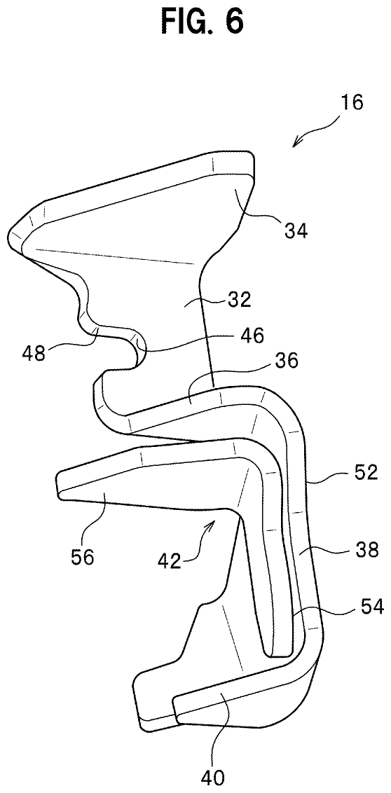

As shown in FIG. 1, the guide member 16 is located under the reservoir tank 14 and provided on the vehicle front end surface 13 of the master cylinder 12. As shown in FIG. 6, this guide member 16 has the fixed portion 32, the extending portion 34, a first bent portion (bent portion) 36, an abutment portion 38, a second bent portion 40, and a reinforcement portion 42. Note that, in the event of a frontal collision (including an offset collision), the guide member 16 functions to guide the power unit such as the engine so as to bring it into abutment with the abutment portion 38 to displace the master cylinder 12 outward in the vehicle width direction.

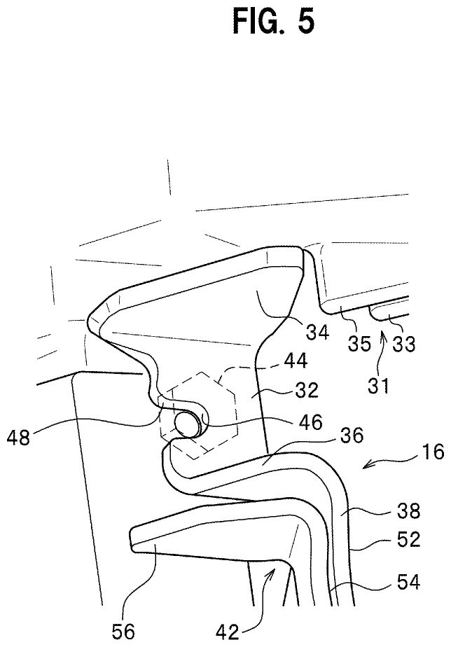

The fixed portion 32 is a flat plate portion having a planar surface extending substantially parallel to the vehicle front end surface 13 of the master cylinder 12, and is fixed to the vehicle front end surface 13 of the master cylinder 12 with the screw member (fixing member) 44 (see FIG. 1). Moreover, as shown in FIG. 5, the fixed portion 32 has a fixing hole 46 to insert the screw member (fixing member) 44 and a slit 48 continuous with this fixing hole 46 and opening outward in the vehicle width direction from the fixing hole 46.

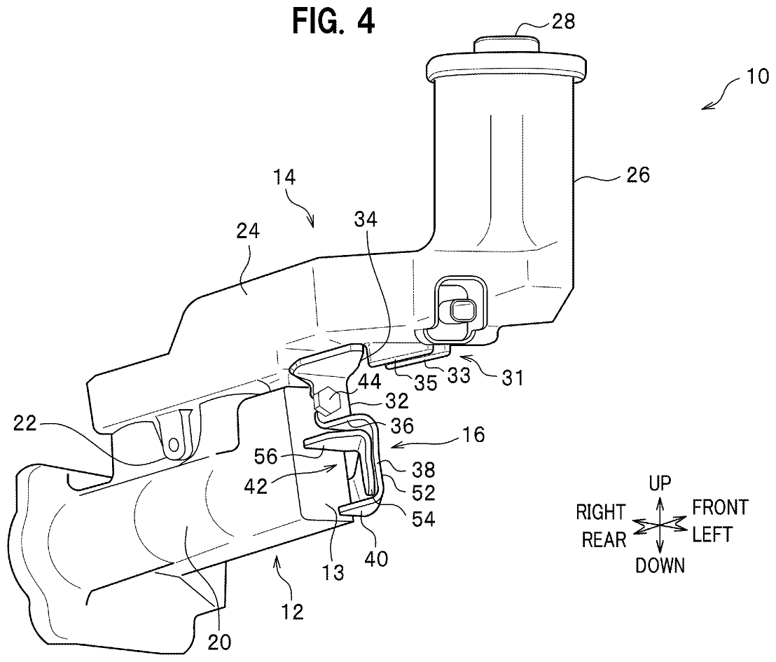

The extending portion 34 assumes a substantially triangular shape in a bottom view (see FIGS. 4 to 6), and is formed so as to extend toward the front side of the vehicle from the fixed portion 32 and overlap the overhanging portion 30 of the reservoir tank 14 in the vehicle up-down direction (see FIG. 1). In other words, the extending portion 34 is provided so as to bend toward the front side of the vehicle from the upper end of the fixed portion 32 and extend toward the front side of the vehicle by a predetermined length along the lower end of the reservoir tank 14. In the present embodiment, the extending portion 34 is provided out of contact with the lower end of the reservoir tank 14 but is not limited to this state, and may be in contact with the lower end.

The extending portion 34 also has the tapered portion 50, whose region on the inner side in the vehicle width direction gets narrower toward the front side of the vehicle in a bottom view. As shown in FIG. 3, this tapered portion 50 includes an extending portion 34 extending in the vehicle front-rear direction on the outer side in the vehicle width direction and an extending portion 34 tilted to extend downward from the outer side in the vehicle width direction toward the inner side in the vehicle width direction. In other words, the edge portion of the extending portion 34 on the inner side in the vehicle width direction (tapered portion 50) is tilted so as to get closer to the outer side in the vehicle width direction toward the front side of the vehicle.

At the lower end of the fixed portion 32, the first bent portion 36 bending toward the front side of the vehicle is provided (see FIGS. 4 and 6). At the end of the first bent portion 36 on the front side of the vehicle, the abutment portion 38 (see FIGS. 2 and 4) is continuously provided, which is tilted with respect to the vehicle front end surface 13 of the master cylinder 12 from the outer side in the vehicle width direction toward the inner side in the vehicle width direction.

The abutment portion 38 has the abutment surface 52, which is continuous with the fixed portion 32 via the first bent portion 36 and tilted so as to be directed toward the inner side in the vehicle width direction (see FIG. 2). The extending portion 34 is disposed outward of at least part of this abutment surface 52 in the vehicle width direction (see the broken line in FIG. 2). Also, at least part of the extending portion 34 is disposed outward of the fixed portion 32 in the vehicle width direction (see FIG. 2).

At the lower end of the abutment portion 38, the second bent portion 40 bending toward the rear side of the vehicle (the vehicle front end surface 13 of the master cylinder 12) is provided (see FIG. 6).

The reinforcement portion 42 is integrally joined to the abutment portion 38 (the back surface of the abutment surface 52) by welding (e.g., spot welding or the like), and disposed outward of the abutment surface 52 in the vehicle width direction. This reinforcement portion 42 has a reinforcement surface 54 (see FIG. 6) overlapping the abutment surface 52 in the vehicle width direction and the vehicle front-rear direction, and a protruding portion 56 (see FIG. 2) bending from the reinforcement surface 54 and extending toward the outer side in the vehicle width direction along the vehicle front end surface 13 of the master cylinder 12. The reinforcement portion 42 is formed as a separate body from the fixed portion 32 of the guide member 16, the extending portion 34, the first bent portion 36, the abutment portion 38, and the second bent portion 40. Also, the reinforcement portion 42 is formed to be bent in a substantially L-shape as viewed obliquely from the front side of the vehicle (see FIG. 6).

The vehicle brake apparatus 10 according to the present embodiment is basically configured as described above. Next, its operation and advantageous effects will be described.

In the present embodiment, the vehicle brake apparatus 10 includes the guide member 16 provided on the vehicle front end surface 13 of the master cylinder 12. In the present embodiment, the reservoir tank 14 has the overhanging portion 30 hanging over the master cylinder 12 toward the front side of the vehicle. This guide member 16 has the fixed portion 32 to be fixed to the master cylinder 12, and the extending portion 34 extending toward the front side of the vehicle from this fixed portion 32 and overlapping the overhanging portion 30 in the vehicle up-down direction. Also, the reservoir tank 14 has the rib portion 31 protruding toward the lower side of the vehicle, and at least part of this rib portion 31 is disposed to overlap the extending portion 34 of the guide member 16 in the vehicle front-rear direction.

In the present embodiment, although the axial dimension of the master cylinder 12 is so short that the reservoir tank 14 overhangs toward the front side of the vehicle, the extending portion 34 of the guide member 16 supports the lower side of the overhanging portion 30 in a preferable manner. For example, when the reservoir tank 14 is de-aired, a jig (not shown) is mounted on the cap 28 of the reservoir tank 14 and vacuuming is performed. At this time, the jig (not shown) inputs a load into the overhanging portion 30 of the master cylinder 12 that can cause a displacement toward the lower side of the vehicle. In the present embodiment, even when such a load is input into the overhanging portion 30 of the master cylinder 12 toward the lower side of the vehicle, the extending portion 34 of the guide member 16 supports the overhanging portion 30. This prevents deformation of the reservoir tank 14 and improves its durability.

Moreover, in the present embodiment, the overhanging portion 30 of the reservoir tank 14 is provided with the rib portion 31. This enhances the durability of the reservoir tank 14 against deformation and improves the ease of layout on the vehicle. For instance, harnesses, hoses, and the like, for example, are disposed around the reservoir tank 14 and the master cylinder 12 and are easily interfered, but improving the ease of layout on the vehicle can prevent this interference.

Also, in the present embodiment, the fixed portion 32 is fixed to the vehicle front end surface 13 of the master cylinder 12. The guide member 16 has the abutment surface 52, which is continuous with the fixed portion 32 and tilted so as to be directed toward the inner side in the vehicle width direction. The rib portion 31 is disposed outward of at least part of the abutment surface 52 of the guide member 16 in the vehicle width direction.

In the present embodiment, the rib portion 31 is disposed outward of at least part of the abutment surface 52 of the guide member 16 in the vehicle width direction. Thus, when a frontal collision load (including an offset load) is input, it is possible to avoid interference between the power unit such as the engine and the rib portion 31 in a preferable manner at the moment when the power unit collides with the abutment surface 52 of the guide member 16. Accordingly, in the present embodiment, it is possible to prevent deformation of the reservoir tank 14 when the frontal collision load is input, and improve its durability.

Moreover, in the present embodiment, the extending portion 34 of the guide member 16 is disposed outward of at least part of this abutment surface 52 in the vehicle width direction.

In the present embodiment, at least part of the extending portion 34 of the guide member 16 is disposed outward of the abutment surface 52 in the vehicle width direction. Thus, when a frontal collision load is input, it is possible to avoid interference between the power unit such as the engine and the extending portion 34 in a preferable manner at the moment when the power unit collides with the abutment surface 52 of the guide member 16. Accordingly, in the present embodiment, it is possible to prevent deformation of the reservoir tank 14 when the frontal collision load is input, and improve its durability.

Furthermore, in the present embodiment, at least part of the extending portion 34 of the guide member 16 is located higher than the lower ends of the vehicle rear end portions 37a and 37b of the rib portion 31.

In this way, in the present embodiment, the extending portion 34 of the guide member 16 is disposed closer to the reservoir tank 14 than the lower ends of the vehicle rear end portions 37a and 37b of the rib portion 31 are. This prevents deformation of the reservoir tank 14 when a frontal collision load is input, and improves its durability.

Furthermore, in the present embodiment, the extending portion 34 has the tapered portion 50, whose region on the inner side in the vehicle width direction gets narrower toward the front side of the vehicle.

In this way, in the present embodiment, it is ensured that the extending portion 34 has a certain area of contact with the overhanging portion 30. This further improves the durability of the reservoir tank 14 against deformation. Moreover, in the present embodiment, when a frontal collision load is input, it is possible to avoid interference between the power unit such as the engine and the extending portion 34 in a preferable manner at the moment when the power unit collides with the abutment surface 52 of the guide member 16.

Furthermore, in the present embodiment, the rib portion 31 extends along the vehicle front-rear direction. The vehicle rear end portions 37a and 37b of this rib portion 31 are disposed inward of the tapered portion 50 of the guide member 16 in the vehicle width direction and disposed so as to overlap the tapered portion 50 in the vehicle width direction.

In the present embodiment, when a frontal collision load (including an offset load) is input, it is possible to avoid interference between the power unit such as the engine and the extending portion 34 in a preferable manner at the moment when the power unit collides with the abutment surface 52 of the guide member 16, while also enhancing the rigidity of the inner side in the vehicle width direction relative to the tapered portion 50 with the rib portion 31. Accordingly, in the present embodiment, it is possible to prevent deformation of the reservoir tank 14 when the frontal collision load is input, and further improve its durability.

Furthermore, in the present embodiment, the overhanging portion 30 has the downwardly protruding portion 27 protruding downward from the bottom surface of the reservoir tank 14. The rib portion 31 is disposed between this downwardly protruding portion 27 and the extending portion 34 of the guide member 16 in the vehicle front-rear direction.

In the present embodiment, the rib portion 31 is disposed between the downwardly protruding portion 27 of the reservoir tank 14 and the extending portion 34 of the guide member 16 in the vehicle front-rear direction. This enhances the rigidity of the whole reservoir tank 14 in the vehicle front-rear direction.

Furthermore, in the present embodiment, the vehicle rear end portions 37a and 37b of the rib portion 31 are disposed outward of the vehicle front end portions 39a and 39b of the rib portion 31 in the vehicle width direction, respectively.

In the present embodiment, the rib portion 31 is disposed to be tilted along the vehicle front-rear direction. This improves the ease of layout on the vehicle while also preventing deformation of the reservoir tank 14 when a frontal collision load is input, and further improving its durability.

What is claimed is:

1. A vehicle brake apparatus comprising:
a master cylinder mounted to a dash panel of a vehicle;
a reservoir tank mounted to a portion of the master cylinder on an upper side of the vehicle; and
a guide member provided at an end portion of the master cylinder on a front side of the master cylinder, wherein
the reservoir tank having an overhanging portion hanging over the master cylinder toward the front side of the vehicle, wherein
the guide member has a fixed portion to be fixed to the master cylinder, and an extending portion extending toward the front side of the vehicle from the fixed portion and overlapping the overhanging portion in a vehicle up-down direction,
the overhanging portion has a rib portion protruding toward a lower side of the vehicle, and
at least part of the rib portion overlaps the extending portion in a vehicle front-rear direction.

2. The vehicle brake apparatus according to claim 1, wherein
the fixed portion is mounted to an end surface of the master cylinder on the front side of the vehicle,
the guide member has an abutment surface continuous with the fixed portion and directed toward an inner side in a vehicle width direction, and
the rib portion is disposed outward of at least part of the abutment surface in the vehicle width direction.

3. The vehicle brake apparatus according to claim 2, wherein the extending portion is disposed outward of at least part of the abutment surface in the vehicle width direction.

4. The vehicle brake apparatus according to claim 1, wherein at least part of the extending portion is located higher than a lower end of an end portion of the rib portion on a rear side of the vehicle.

5. The vehicle brake apparatus according to claim 4, wherein the extending portion has a tapered portion whose region on an inner side in a vehicle width direction gets narrower toward the front side of the vehicle.

6. The vehicle brake apparatus according to claim 5, wherein
the rib portion extends along the vehicle front-rear direction, and
the end portion of the rib portion on the rear side of the vehicle is disposed inward of the tapered portion in the vehicle width direction and overlaps the tapered portion in the vehicle width direction.

7. The vehicle brake apparatus according to claim 4, wherein
the overhanging portion has a downwardly protruding portion protruding downward from a bottom surface of the master cylinder, and
the rib portion is disposed between the downwardly protruding portion and the extending portion in the vehicle front-rear direction.

8. The vehicle brake apparatus according to claim 7, wherein
the end portion of the rib portion on the rear side of the vehicle is disposed outward of an end portion of the rib portion on the front side of the vehicle in a vehicle width direction.
